(19) United States
(12) Patent Application Publication
(10) Pub. No.: US 2023/0409274 A1
(43) Pub. Date: Dec. 21, 2023

(54) COMMUNICATIVE LIGHTING SYSTEMS

(71) Applicant: GET LIT LLC, Wichita, KS (US)

(72) Inventors: Montano Ysidro, Wichita, KS (US); Jason Bell, Wichita, KS (US); Tom McGuire, Wichita, KS (US); John Harrison, Wichita, KS (US)

(21) Appl. No.: 18/212,064

(22) Filed: Jun. 20, 2023

Related U.S. Application Data
(60) Provisional application No. 63/353,394, filed on Jun. 17, 2022.

(51) Int. Cl. G06F 3/147; H04R 1/02; G06F 3/044

(52) U.S. Cl. CPC G06F 3/147; H04R 2499/15; G06F 3/044; H04R 1/028

(57) ABSTRACT

A communicative lighting system in some embodiments comprises a plurality of network connected light sources including display screens. Each light source in some embodiments possess a unique identifier permitting the light sources to be associated with one another. An input received by one light source in some embodiments alter the light output and display screen of that light source as well as the associated light sources. The light output of a light source in some embodiments is capable of being altered by changing color, brightening or dimming, blinking, adjusting which of a plurality of light emitting diodes are activated, or otherwise modifying the type or amount of light output. The display screen in some embodiments is capable of being altered to display a different image or video.

### CROSS-REFERENCE TO RELATED APPLICATIONS

This application claims priority to U.S. Provisional Patent Application Ser. No. 63/353,394, filed Jun. 17, 2022, the entire disclosure of which is incorporated herein by reference.

### FIELD OF THE INVENTION

The present invention relates generally to lighting. More specifically, the present invention is concerned with connected lighting systems.

### BACKGROUND

Light has been used for both illumination and communication for time immemorial. Surely, since shortly after humans harnessed the power of fire sharing light has been a way to express welcome and belonging. Of course, specific intentions can be expressed using light as well. In America, “one if by land, two if by sea,” is a famous example of the use of light to communicate information. Light sources such as bonfires, lanterns, and stoplights have long been used to communicate welcome, availability, and other information to those who can view the light provided by those light sources.

### SUMMARY

The present invention permits the use of light for communication over distances greater than the distance from which a light source may be directly viewed. Two or more light sources are capable of being associated with one another, such that a first light source alters the operation of at least the second light source, or vice versa. While a person viewing the second light source may be well out of sight of the first light source, the change in illumination by the second light source in response to the remote first light source is capable of communicating using the emotional power of light across distances not before possible. By associating network connected light sources with one another, the present invention permits one or more individuals to communicate thoughts and emotions over a great distance.

In some examples, the present invention comprises a communicative lighting system. Some embodiments of such an exemplary system comprise a first light source connected to a first network, the first light source having at least one input mechanism, at least one light output mechanism, and a permanently assigned first identifier retained in a non-transitory computer-readable memory within the first light source, the non-transitory computer-readable memory within the first light source further providing computer readable instructions to be executed by a computer processor within the first light source. Some embodiments of such an exemplary system further comprise a second light source connected to a second network, the second light source having at least one input mechanism, at least one light output mechanism, and a permanently assigned second identifier retained in a non-transitory computer-readable memory within the second light source, the non-transitory computer-readable memory within the second light source further providing computer readable instructions to be executed by a computer processor within the second light source. Some embodiments of such an exemplary system yet further comprise a server connected to at least one network accessible to both the first light source via the first network and the second light source via the second network, the server receiving messages from at least the first light source and the second light source to associate the first light source and the second light source with one another, such that when an input is made using the at least one input mechanism at the first light source the operation of the at least one light output mechanism of the second light source alters and such that when an input is made using the at least one input mechanism at the second light source the operation of the at least one light output mechanism of the first light source alters. In examples, the computer readable instructions retained in the non-transitory computer-readable memories of the first light source and the second light source is capable of causing the computer processors of the first light source and the second light source to contact the server to register a network address of each of the first light source and the second light source, and the receipt of an input at the input mechanism of the first light source is capable of causing a message to be transmitted from the first light source to the server and then from the server to the second light source to alter the operation of the at least one light output mechanism of the second light source, and the receipt of an input at the input mechanism of the second light source is capable of causing a message to be transmitted from the second light source to the server and then from the server to the first light source to alter the operation of the at least one light output mechanism of the first light source. In some examples, the at least one input mechanism of the first light source and the at least one input mechanism of the second light source in some embodiments comprises a touch-sensitive surface on a shade covering the at least one light output mechanism. In some examples, the touch-sensitive surface comprises a conductive ink applied to a shade panel, and/or a conducting frame that retains a shade panel, and/or a base section of the light source. In further examples, the at least one light output mechanism of the first light source and the second light source comprise a plurality of light emitting diodes. In some examples, altering the operation of the plurality of light emitting diodes comprise changing the color of the light emitted by the plurality of light emitting diodes. In yet further examples, the computer readable instructions retained in the non-transitory computer-readable memories of the first light source and the second light source in some embodiments further cause the computer processors of the first light source and the second light source to dim the light output from the plurality of light emitting diodes over time if no further inputs are received by the first light source and the second light source. In additional examples, the computer readable instructions retained in the non-transitory computer-readable memories of the first light source and the second light source cause the first light source and the second light source to be accessible over a data connection by a computing device to configure the operation of the light source. In examples, configuring the operation of the first light source using the computing device to access the light source over the data connection comprise entering the unique identifier of the second light source to pair the first light source and the second light source in at the server.

In some examples in accordance with the present invention, a communicative lighting system comprise a plurality of light sources, each of the plurality of light sources comprising a plurality of light emitting diodes contained within a shade, an input mechanism, a wireless network connection providing a data connection to at least one wireless network, at least one computer processor that receives inputs from the input mechanism, controls the output of the light emitting diodes, and sends and receives communications over the wireless network connection, and a non-transitory computer-readable memory containing a permanently assigned unique identifier corresponding to that light source and computer readable instructions retained in a non-transitory form to be executed by a computer processor within the first light source to perform at least part of a method of interaction between at least two of the plurality of light sources. Such an exemplary system in accordance with the present invention in some embodiments further comprise a server accessible by at least some of the plurality of light sources via at least one network, the server having at least one computer processor operating based upon computer-readable instructions retained in a non-transitory form to cause the server to perform at least part of the method of interaction between at least two of the plurality of light sources. In examples, the method of interaction between at least two of the plurality of light sources comprise, in response to an input received at an input device of a first light source, altering the output of the plurality of light emitting diodes of the first light source; in response to an input received at an input device of a first light source, transmitting a message to at least a second light source; and at the second light source, in response to the message from the first light source, altering the output of the plurality of light emitting diodes of the second light source. In examples, the method further comprise configuring at least a pair of the plurality of light sources using a computing device connected via the wireless network connection of at least one of the pair of the plurality of light sources to enter the unique identifier of at least one other of the plurality of light sources to be associated with the at least one of the pair of light sources at the server. In examples of systems in accordance with the present invention, the input mechanism of at least some of the plurality of light sources comprise a conductive ink applied to at least a portion of the shade of the light source. In further examples of systems in accordance with the present invention, the input mechanism of at least some of the plurality of light sources comprise a conductive frame retaining at least a panel of the shade of the light source. In some examples of the present invention, altering the output of the plurality of light emitting diodes comprise altering the color of light emitted. In yet further examples of systems in accordance with the present invention, the method of interaction between at least two of the plurality of light sources further comprise transmitting messages between light sources via the server. In yet further examples of systems in accordance with the present invention, the method of interaction between at least two of the plurality of light sources further comprise dimming the light emitted from the light emitting diodes of the light source as a function of time if the light source does not receive an input from the input device or a message from another light source.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

A preferred embodiment of the invention, illustrative of the best mode in which the applicant has contemplated applying the principles, is set forth in the following description and is shown in the drawings and is particularly and distinctly pointed out and set forth in the appended claims.

FIG. 1 schematically illustrates an example of a pair of networked lights in accordance with the present invention;

FIGS. 2A-2C schematically illustrate an example of a lighting system in accordance with the present invention;

FIG. 3 illustrates an example of panels that are capable of being assembled to form the shade of a lighting system in accordance with the present invention;

FIG. 4 illustrates a perspective view of an example of a lighting system in accordance with the present invention assembled by affixing the exemplary panels of FIG. 3 to a base;

FIG. 5 schematically illustrates an example of a cross section of a panel that is capable of being used in lighting system in accordance with the present invention;

FIG. 6 illustrates an example of a method for creating a lighting system in accordance with the present invention; and

FIG. 7 illustrates an example of a method of operating communicative lighting systems in accordance with the present invention.

### DETAILED DESCRIPTION

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

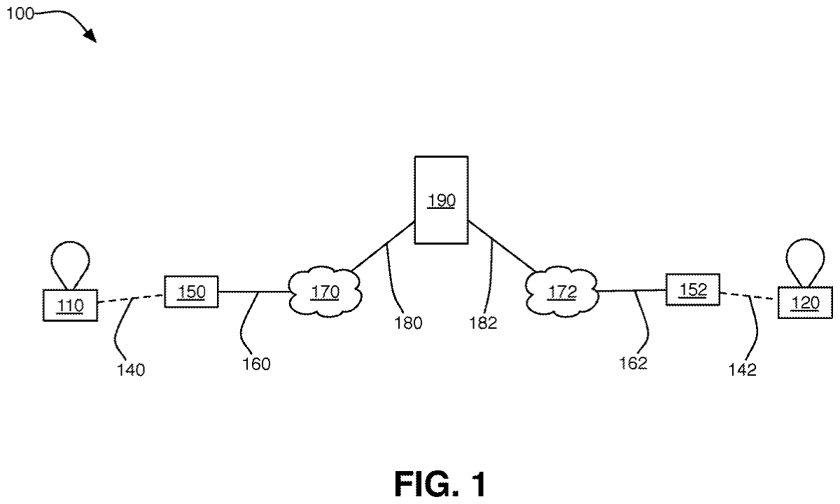

FIG. 1 schematically illustrates an example of a system 100 in accordance with the present invention for using network connected light sources to communicate across a distance with other associated light sources. A first light source 110 and a second light source 120 are illustrated in the example of FIG. 1, but additional light sources beyond the pair illustrated in the example of FIG. 1 are used in various embodiments in accordance with the present invention. For example, a system in accordance with some embodiments of the present invention, such as system 100, provide a plurality of associated pairs of light sources and/or other associated groupings involving more than two light sources.

In the example of FIG. 1, a first light source 110 uses a wireless connection 140 to access a network router 150. For example, a network router 150 in some embodiments comprises a wireless router and wireless connection 140 in some embodiments comprises communications exchanged between the first light source 110 and the network router 150 using a wireless protocol. Network router 150 in some embodiments connects 160, via any desired media and protocol, to a network 170, such as the Internet. Similarly, second light source 120 is in some embodiments wirelessly connected 142 to a network router 152 connected 162 to a network 172 such as the Internet. The network 170 accessed by the first light source 110 and the network 172 accessed by the second light source 120 in some embodiments comprise different networks or the same network. A first network 170 and a second network 172 are illustrated as distinct networks in the example of FIG. 1 for exemplary purposes only. Further, one or both of first network 170 and second network 172 in some embodiments each comprise multiple networks or subnetworks. The example of FIG. 1 omits elements of system 100 that facilitate accessing and operating networks 170, 172, such as routers, switches, Domain Name Servers, and the like for the sake of clarity.

Still referring to the example of FIG. 1, a server 190 in some embodiments connect 180 to first network 170 and in some embodiments connect 182 to second network 172. Each of first connection 180 and second connection 182 in some embodiments comprise packets exchanged with server 190 over one or more network. Server 190 in some embodiments exchange packet-based communications with first light source 110 and/or second light source 120. In some examples, an address (such as an IP address or a domain name that is capable of being be mapped by DNS) for server 190 in some embodiments is provided to lighting devices (such as first light source 110 and second light source 120, as well as any additional light sources not illustrated in the example of FIG. 1) to permit a light source to access server 190 for purposes of initial setup and subsequent communication. Such a server 190 address in various embodiments is permanent or temporary. An address in some embodiments also is associated with each light source in FIG. 1 for use in routing communications to the light source, but those addresses in some embodiments are assigned by an entity such as an internet service provider (and may therefore change from time to time) and are often blocked by a firewall, so accordingly the light source is capable of providing its address to the server 190 for use in exchanging communications. To facilitate the unique identification of individual light sources, each light source in a system in accordance with the present invention in some embodiments receive a unique identifier, such as an alphanumeric code, that is capable of being used to identify an individual light source independent of any address associated with that light source. Such a unique code in some embodiments is provided during the manufacturing of a given light source.

Server 190 in some embodiments is used to facilitate communication between the first light source 110 and the second light source 120 (and/or additional light sources not illustrated in the example of FIG. 1). For example, if first light source 110 is appropriately engaged by a user physically interacting with first light source 110, first light source 110 in some embodiments transmit information to server 190. Based upon the information received by server 190 from first light source 110, server 190 in some embodiments transmit information to second light source 120. The information ultimately transmitted to second light source 120 at the initiation of first light source 110 in some embodiments activate or in some other way alter the operation of second light source 120. In a similar fashion, a user engaging second light source 120 in some embodiments cause the transmission of a message to server 190 that causes server 190 to propagate a message to first light source 110 to causes the first light source 110 to activate or otherwise alter its operation.

In some examples of conventional network configurations, a firewall provided by a router or a switch in some embodiments is present between light sources (such as light source 110, 120) and a server (such as server 190), and in such an example the IP address of the firewall in some embodiments is provided to the server(s) for use to route communications to a light source. Such a firewall will also often prevent the server(s) from initiating a connection with a light source. In some such examples, a light source is initially open a communication channel with the server(s), with messages sent from the light source to the server(s) at periods (such as every sixty seconds) to keep that communication channel open, thereby permitting the server(s) to use the open channel to send communications to the light source. If the connection between a light source and a server is broken, the light source in some embodiments seek to re-initiate the connection. If the attempted re-initiation of a connection with a server fails, a light source in some embodiments provide an appropriate error message for a user.

Systems and methods in accordance with the present invention enable a remote light source to activate or alter the operation of a local light source, and likewise permit a local light source to activate or alter the operation of a remote light source. Whether a given light source is “local” or “remote” is a matter of whether a given user is able to physically interact with the light source and perceive light emitted by the light source; a single light source in some embodiments is both a “local” light source and a “remote” light source at the same time.

The activation or alteration of a light source by a remote light source in various embodiments take a variety of forms. For example, a remote light source in some embodiments simply cause a local light source to activate and emit light. In other examples, a particular color of light in some embodiments is emitted by a local light source in response to a remote light source, potentially with different colors of light associated with different remote light sources. The alteration of the behavior of a local light source based upon inputs provided by a user of a remote light source in some embodiments comprise any manipulation of the light emitted by the local light source. For example, the light intensity, color, flashing, duration, or other property in some embodiments is controlled based upon an input received at a remote light source.

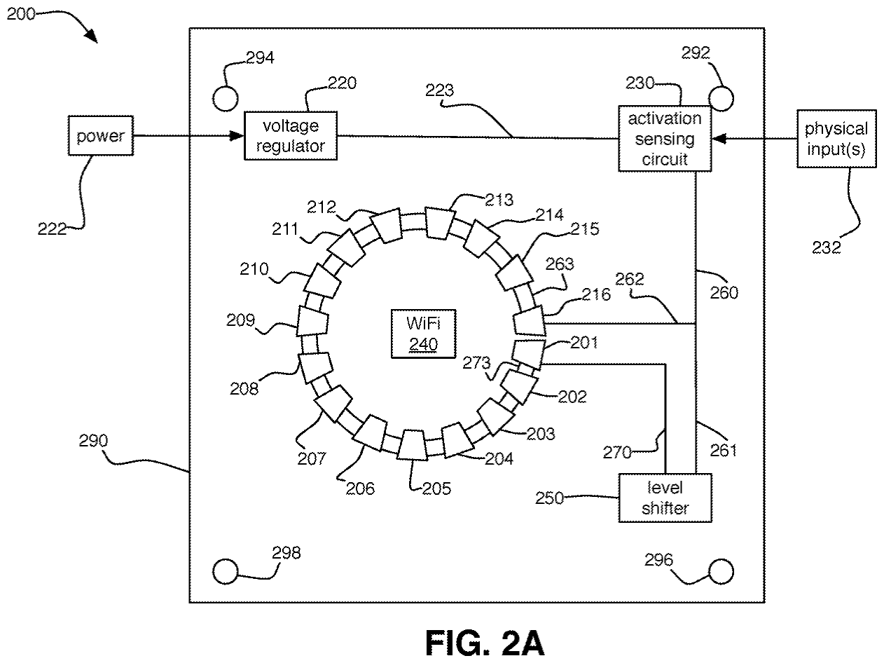

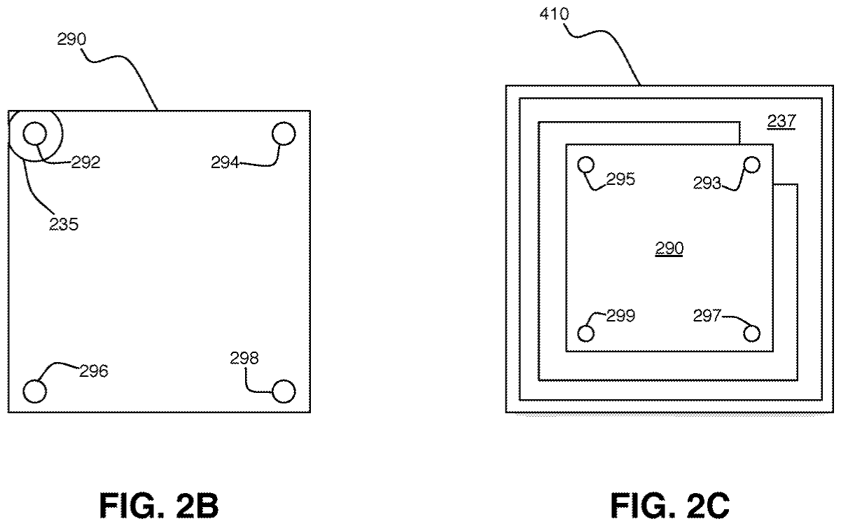

While the light sources 110, 120 depicted in the example of FIG. 1 need not be limited to a first light source 110 and a second light source 120, they likewise need not be limited to a particular type of light source. For example, light emitting diodes (LEDs), incandescent bulbs, compact fluorescent bulbs, fluorescent bulbs, or other light generating technologies in some embodiments are used in some or all of the light sources provided in a system such as exemplary system 100 depicted above in FIG. 1. A single light source in some embodiments comprise one or more individual elements that emit light. One example of an appropriate light source providing multiple individual LEDs that emit light is illustrated in the example of FIGS. 2A-2C and described further below, but the present invention is not limited to this example.

Referring now to FIG. 2A, a lighting device 200 in some embodiments use a plurality of electrical components provided on one or more printed circuit board 290. Printed circuit board 290 in some embodiments contain a plurality of circuit elements and microcontrollers to permit a lighting device 200 to operate as described herein. Printed circuit board 290 in some embodiments have a size and shape that permits it to be mounted on a base 410 and/or contained within a shade assembly or other housing when the lighting device 200 is assembled for use. A plurality of holes 292, 294, 296, 298 in some embodiments are provided to receive screws 293, 295, 297, 299 to retain printed circuit board 290 to base 410 and, if a capacitive sensing system as described in examples herein is used, to establish reliable electrical connections between elements of circuit board 290 and input regions on lighting device 200. Input regions in some embodiments comprise a conducting portion of a shade panel, a conductive portion of a frame that retains one or more shade panel, a conductive portion of a base, or any other input mechanism electrically connected to printed circuit board 290. In some examples of systems and methods in accordance with the present invention, a printed circuit board 290 in some embodiments are replaced, in whole or in part, but electrical connections between the electrical components described in conjunction with the example of FIG. 2.

Printed circuit board 290 in some embodiments provide a plurality of elements that emit light, such as a plurality of LEDs, to produce light in response to an input received from a user locally and/or in input received from a remote user at a remote light source associated with the local light source 200. In the example of FIG. 2A, sixteen light emitting diodes 201-216 in some embodiments are arranged in a circular fashion, but more or fewer LEDs in different geometric arrangements, or even light emitting elements other than LEDs, in some embodiments are used with a light source in accordance with the present invention. The LEDs 201-216 in some embodiments are capable of emitting light at a variety of wavelengths and/or a variety of intensities. The wavelength of emitted light, the intensity of emitted light, and which of the plurality of diodes is activated to emit light at a given wavelength or intensity in some embodiments are controlled using circuitry and/or software provided elsewhere on the lighting source 200. One example of LEDs that in some embodiments are used in accordance with the present invention are WS2812 RGB LEDs connected in a daisy chain and (optionally) individually addressable by a microcontroller. A lighting device having individually addressable LEDs in some embodiments adjust the on/off status, color, and/or intensity of single LEDs (or groups of LEDs, if desired) simultaneously.

A wireless connection module 240 in some embodiments is provided as part of light source 200. A wireless connection module 240 in some embodiments comprise, for example, one or more antenna and the appropriate hardware to operate in accordance with a wireless communication protocol, such as one of the 802.11 protocols (referred to commonly asked “Wi-Fi”), a Bluetooth protocol, a Zigbee protocol, or other communication protocols. A wide variety of modules that in some embodiments are used as a wireless connection module 240 are commercially available, one example of which is an ESP8266-12e FCC-certified COTS WiFi module available from Espressif Systems (Shanghai) Pte. Ltd.

Light source 200 in some embodiments receive power 222 from a power source such as an electrical outlet and/or a battery. Power 222 in some embodiments is regulated using a voltage regulator 220 to provide power at a voltage acceptable and appropriate to the other electric components of light source 200. The type and voltage rating a voltage regulator 220 used in accordance with the present invention, as well as whether a voltage regulator is used at all, in some embodiments vary based upon the electrical components used in lighting device 200. One example of a voltage regulator 220 that in some embodiments is used in systems and methods in accordance with the present invention is a regulator that receives a 5V input and provides a 3.3V regulated output.

An activation sensing circuit 230 in some embodiments receive physical inputs 232 from a local user. In an example further described herein, capacitance sensing is used to detect a touch from a user, but other types of inputs, such as buttons, levers, dials, keyboards, motion detectors, sound responsive sensors, voice recognition systems, load sensors, light detection, or other input devices in some embodiments provide physical inputs from a local user that are received by activation sensing circuitry 230. In the example of a lighting device 200 operated using touch inputs detected by activation sensing circuit 230, an activation sensing circuit 230 in some embodiments comprise a sensor such as an AT42QT1010 sensor available from Atmel Corporation, although many different sensors in some embodiments are used in the example of a lighting device operated by receiving user inputs based upon capacitive sensing. If capacitive sensing is used in a lighting device 200 in accordance with the present invention, a reliable electrical contact must be made between the activation sensing circuit(s) 230 and the touch surface(s) of lighting device 200 that are to receive those inputs.

A level shifter 250 in some embodiments control the response of light source 200, particularly the activation status, wavelength, and/or intensity of LEDs 201-216 activated by lighting device 200. Level shifter 250 in some embodiments receive inputs from activation sensing circuit 232 and/or inputs from wireless communication module 240 corresponding to inputs received at a remote lighting device (not illustrated in FIG. 2). Level shifter 250 in some embodiments additionally relay locally received inputs from a user to the wireless communication module 240 for transmission to a remote lighting device associated with the lighting device 200.

Level shifter 250 in some embodiments further control the activation of one or more LED 201-216 even in absence of an input by adjusting the operation of one or more LED based upon the time lapsed since one or more prior input. For example, an input received in some embodiments initially activate the LEDs 201-216 at a given intensity, which in some embodiments then gradually reduce the intensity over a period of time, such as five minutes, thirty minutes, an hour, or multiple hours. Further, the operation and response of LEDs 201-216 in some embodiments vary based upon parameters such as the time of day, the last input received, the type of input received, etc. Level shifter 250 in some embodiments comprise various types of digital and/or analogue circuits, such as a microcontroller. One example of a microcontroller that in some embodiments is used with systems and methods in accordance with the present invention is a BSS138 N-Channel Logic Level Enhancement Mode Field Effect Transistor available from Fairchild Semiconductor, although other microprocessors in some embodiments are used without departing from the scope of the present invention.

While the example of FIG. 2A illustrates a light source 200 having a discrete activation sensing circuit 230, wireless communication module 240, and level shifter 250, the functionality of these components in some embodiments are combined into fewer or distributed into more components than are illustrated in the example of FIG. 2A. Further, components providing for functionality in addition to or instead of the functions performed by the components described with regard to the example of FIG. 2A in some embodiments are incorporated into a light source in accordance with the present invention. For example, a light source that receives only touch inputs from a local user and does not distinguish between different types of touches in some embodiments provide elegant simplicity of use, but light sources in accordance with the present invention in some embodiments receive a variety of different inputs that result in different responses by the illumination elements of the light source.

The components of a light source 200 provided on a printed circuit board 290 depicted in the example of FIG. 2A in some embodiments is affixed to a platform, either directly or indirectly, and that platform in some embodiments is used as the base of a light source in accordance with the present invention. A shade in some embodiments is provided for mounting to the platform to provide an aesthetically appealing appearance and, optionally, a touch input mechanism for using the light source. An example of the mounting of the exemplary printed circuit board 290 to an exemplary base 410 is shown in conjunction with FIGS. 2B and 2C.

FIG. 2B illustrates the bottom of printed circuit board 290, flipped to show holes 292, 294, 296, and 298. A sensing pad 235 electrically connected to activation sensing circuit 230 extends along the bottom of printed circuit board 290 around hole 292. Sensing pad 235 permits a reliable electrical connection to be made between activation sensing circuit 230 and a capacitive sensing input region contacted by a user.

FIG. 2C illustrates the printed circuit board 290 affixed to a base 410 using a plurality of screws 293, 295, 297, 299 that pass through holes 292, 294, 296, 298. Printed circuit board 290 in some embodiments is affixed to base 410 oriented as depicted in FIG. 2A, such that sensing pad 235 depicted in FIG. 2B contacts a conductor 237 provided in base 410. Conductor 237 in some embodiments electrically connect sensing pad 235 to a capacitance sensing input zone provided elsewhere on lighting device 200, to permit signals created by a user touching an input zone to be transmitted to activation sensing circuit 230. Conductor 237 in some embodiments comprise a conducting foil retained in base 410 such that screws 293, 295, 297, 299 maintain sensing pad 235 in contact with conductor 237. A conducting foil in some embodiments is constructed of aluminum, copper, gold, or any other conducting material. As depicted in the example of FIG. 2C, the conductor 237 in some embodiments extend within the base 410 around the perimeter of base 410 in order to contact conducting surfaces provided in a shade to serve as one or more capacitive sensing input zone. Conductor 237 in some embodiments overlay a compressible material that permits sensing pad 235 and/or conducting surfaces provided in a shade to be pressed against conductor to establish a reliable electrical connection. In some examples in accordance with the present invention, two-sided foam tape in some embodiments is used both to retain conductor within base 410 and to provide a compressible underlayment beneath conductor.

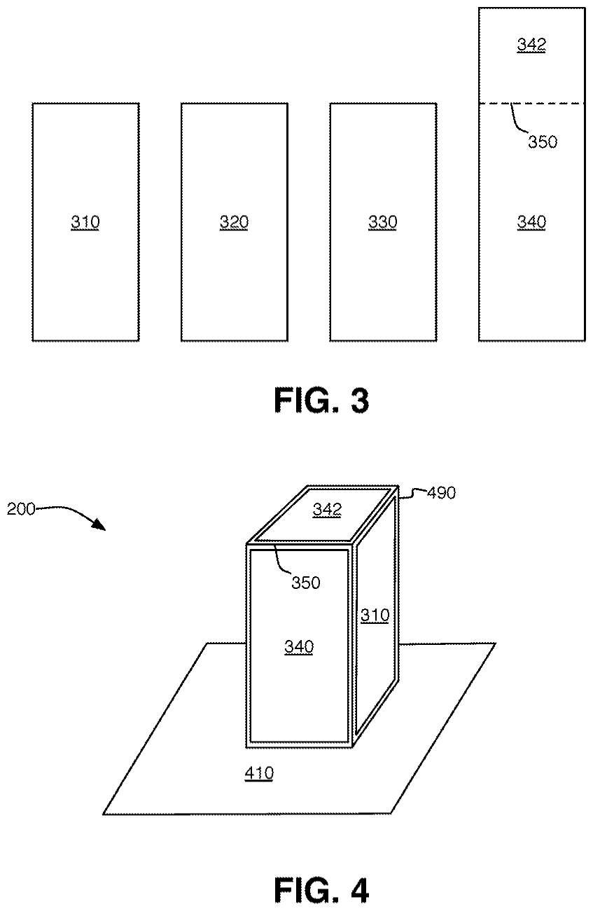

Referring now to FIG. 3 and FIG. 4, one example of a light source 200 assembled from multiple panels that form a shade to enclose the electrical components (such as the example illustrated in FIG. 2A) and to provide an aesthetically pleasing appearance is illustrated. While any number of panels in some embodiments are used to form a shade in accordance with the present invention, the example of FIGS. 3 and 4 illustrate a shade with four sides and a top formed from a first panel 310, a second panel 320, a third panel 330, and a fourth panel 340 retained to base 410 with a frame 490. In the example of FIGS. 3 and 4, capacitance sensing permits an input to be received by light source 400 when a panel 310, 320, 330, 340 is touched by a user. In further examples, capacitance sensing in some embodiments permit an input to be received by light source 400 through frame 490 and/or base 410. As shown in the example of FIG. 3, a first panel 310, a second panel, 320, and a third panel 330 in some embodiments have substantially identical sizes and shapes, while a fourth panel 340 in some embodiments have a top portion 342 that in some embodiments is folded 350 to enclose the top of light source to create a cuboid-shaped shade (i.e., a shade resembling a box). In some examples, however, top portion 342 in some embodiments is omitted or provided as a separate panel. In further examples, the entire shade, of whatever shape, in some embodiments is folded from a single panel or formed from multiple panels in a different construction than depicted in the present example. The various control components and LEDs described in the example of FIG. 2A in some embodiments are affixed to a base 410 and contained within the resulting shade. As explained above with regard to the example of FIG. 2C, an electrical connection in some embodiments is established between a capacitive sensing input zone provided on the panels 310, 320, 330, 340 and the enclosed activation sensing circuit 230.

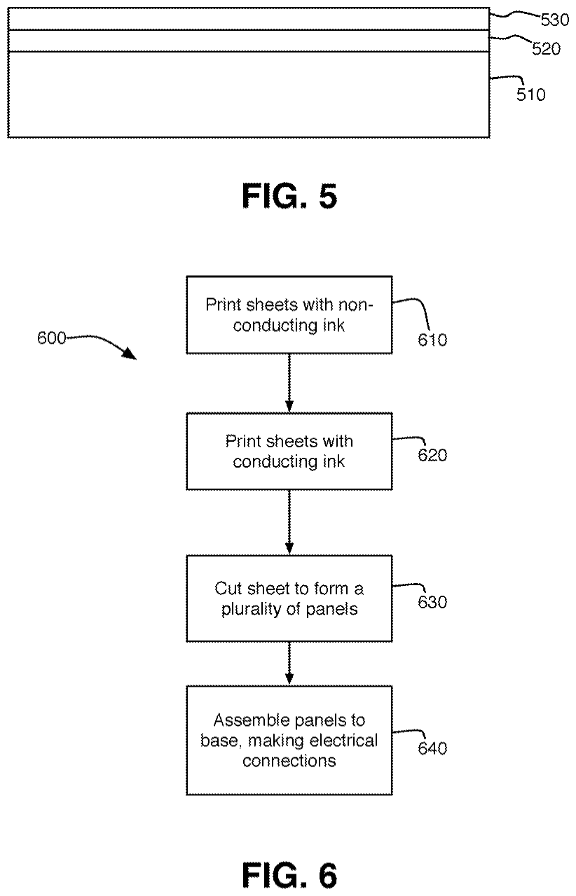

Referring now to FIG. 5, an example of a cross section of panel that in some embodiments provide capacitance sensing for use as both part of a shade and an input mechanism for a light source in accordance with the present invention is illustrated. By using a base sheet formed of a material having a desired resilience, rigidity, and translucence (which in some embodiments vary depending upon the intended location of use or preferences of a use of a light source) and using a layer of conducting material, such as conductive ink or paint, all or part of a shade in some embodiments receive touch inputs from a user that cause a lighting device in accordance with the present invention to alter its illumination and/or to transmit a control message to alter the illumination of a remote lighting device.

A base sheet 510 in some embodiments is comprised of polycarbonate, glass, thin paper, or any other material having physical properties suited to a use environment and a user's preferences. A first layer of ink 520 in some embodiments is applied to sheet 510. The first layer of ink 520 in some embodiments is nonconductive ink. The first layer of ink 520 in some embodiments is black or any other color desired for aesthetic purposes. In some examples, the first nonconductive ink layer 520 in some embodiments is omitted. A conductive layer of ink 530 in some embodiments is applied on top of the first nonconductive layer of ink 520 or, if the first ink layer 520 was omitted, directly onto sheet 510. First layer of ink 520 and a second layer of conductive ink 530 in some embodiments is applied in patterns that provide a pleasing aesthetic effect and/or in some embodiments is selected to possess colors to provide a pleasing aesthetic effect. The sheet 510 in some embodiments is cut into individual panels (such as panels 310, 320, 330, 340) before or after the layer(s) of ink have been applied. Conductive ink in some embodiments is applied to one or more edge of panels 310, 320, 330, 340 that will contact conductor 237 as described in conjunction with FIG. 2C.

Referring now to FIG. 6, an example method 600 for forming a plurality of sheets into a shade for use with a light source, such as a light source 400 illustrated in the example of FIG. 4, is illustrated. Method 600 in some embodiments begin with step 610, in which a sheet in some embodiments is printed with a nonconducting ink having a color and/or pattern that is aesthetically pleasing. In step 620, the sheet in some embodiments is printed with a conducting ink to provide capacitive sensing capabilities to a shade constructed from the sheet. In step 630, the sheet in some embodiments is cut to form a plurality of panels. The number of panels to be cut in step 630 in some embodiments is four, as depicted in the example of FIGS. 3 and 4, but in various embodiments is more or fewer. One or more of the panels cut in step 630 in some embodiments include a top portion for the shade to be formed or in some embodiments serve as a top portion for the shade to be formed. In step 630, the sheets in some embodiments are assembled to a base (such as base 410 depicted in the example of FIG. 4). Step 630 in some embodiments is performed before or after step 610 and/or step 620. The panels in some embodiments is assembled with the conducting ink oriented outwards, toward a user, or in some embodiments are assembled with the conducting ink oriented inward, or away from a user. Capacitive sensing detects proximity of a touch to a conductor and, in many examples, the thickness of a panel and the material from which a panel is constructed does not inhibit detection of a touch (or a near-touch) on the un-inked surface of a panel. Step 640 in some embodiments establish appropriate electrical connections between the conducting ink applied in step 630 and activation sensing circuitry, such as depicted as activation sensing circuitry 230 in the example of FIG. 2A. Step 640 in some embodiments involve providing conducting ink at an edge of the panels and installing the panels to a base (such as base 410) to contact a conductor (such as conductor 237 as shown in FIG. 2C). In this fashion, when a user touches a sheet, the capacitance change resulting from that contact is capable of being detected by the activation sensing circuitry. The activation sensing circuitry in some embodiments use the analog capacitance change over time as a trigger to detect an input, i.e. to activate if the capacitance changes more than a given amount within a certain period of time. In this fashion, the activation sensing circuitry in some embodiments alter the behavior of the light emitted by the lighting device 400 if a touch is detected.

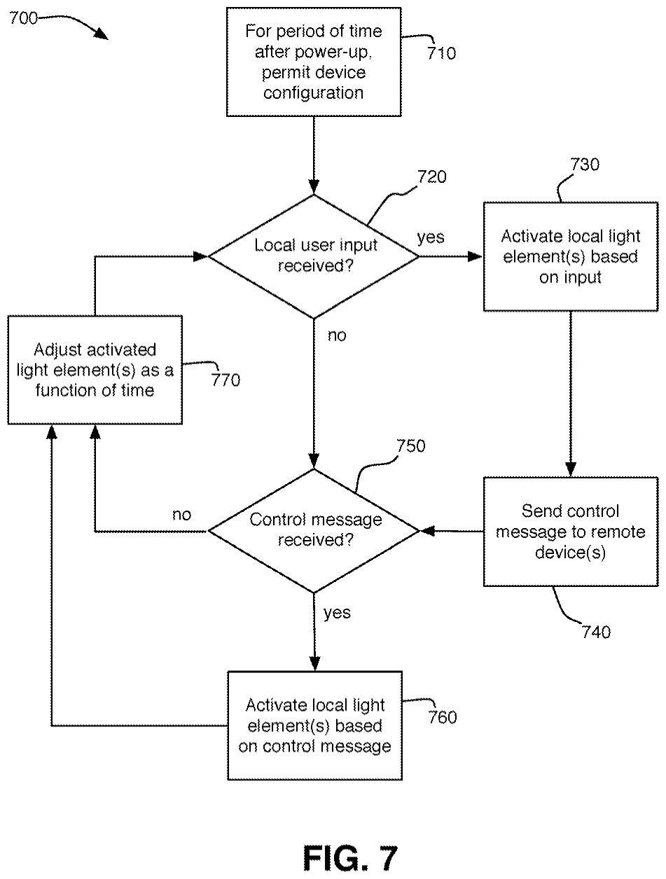

Referring now to FIG. 7, an example of the operation of one of two or more associated lighting devices is illustrated. Method 700 in some embodiments begin with the power on step 710 which in some embodiments permit the configuration of the lighting device for a period of time after the lighting device is connected to a power source. For example, step 710 in some embodiments permit the wireless network connectivity of the lighting device to be configured, to associate the lighting device with another lighting device, to create a password for future modifications, to determine the responses made by the light source to various local or remote inputs, to set time parameters for the modification of illumination as a function of time, to set certain times during which the response of the light source to messages from associated remote light sources will be reduced or eliminated (for example, to prevent an activation from waking a sleeping user), and the like. Step 710 in some embodiments also access a server to check for firmware or software updates.

After the power up and/or set up of step 710 has concluded, method 700 in some embodiments proceed to step 720 to determine whether a local user input has been received. A local user input in some embodiments is received, for example, using a capacitance sensing system such as described above. If the conclusion of step 720 is that a local user input has been received, method 700 in some embodiments proceed to step 730 and step 740. If the conclusion of step 720 is that no local user input is received, method 700 in some embodiments proceed to step 750.

If a local user input is received in step 720, in step 730 the local light elements (such as LEDs contained in the lighting device) in some embodiments are activated based on that input. The activation performed in step 730 in some embodiments is based upon a configuration made in step 710. For example, which light element is activated and how it is activated in some embodiments is defined in configuration step 710. Activating one or more light element in step 730 in some embodiments switch one or more light element between an on/off status, in some embodiments modify the color or intensity emitted by one or more light element, in some embodiments alter (or initiate or stop) the pattern of flashes of one or more light element, or otherwise modify the behavior of one or more light element. The activation of one or more local light element in step 730 in some embodiments vary based upon the time of day, the status of the lighting device or an individual light element (such as what color of light is being emitted in response to a prior input), etc. Such variations in some embodiments are designated in configuration step 710 in some examples. In some examples, a lighting device or an individual light element in some embodiments cycle through a number of predetermined levels (which in some embodiments is predetermined for all lighting devices of a particular type in accordance with the present invention or predetermined at configuration step 710), with a shift made from one level to another made for each input received, whether the input is received locally or remotely.

If step 720 determines that a local user input has been received, method 700 in some embodiments also proceed to step 740 to send a control message to one or more associated remote lighting device. The type of control message sent in step 740 in some embodiments is based upon a configuration set in step 710. Step 740 in some embodiments use an intermediate server or servers to transmit such a control message. The control message(s) transmitted in step 740 in some embodiments alter the behavior of the remote lighting device as described herein in conjunction with method 700 or in accordance with another method.

Whether method 700 proceeds directly from step 720 to step 750 or whether method 700 detects a local input in step 720 and proceeds through steps 730 and steps 740 before arriving at step 750, method 700 in some embodiments arrive at step 750 to determine whether a control message has been received from an associated remote lighting device. A control message received in step 750 in some embodiments ultimately originate from an associated remote lighting device, but in some embodiments is transmitted via one or more server over a network such as the Internet. If the conclusion of step 750 is that no control message has been received, method 700 in some embodiments proceed to step 770 (described further below) and return to step 720 to determine whether a local user input has been received. If the conclusion of step 750 is that a control message has been received, method 700 in some embodiments proceed to step 760.

In step 760, one or more local light element in some embodiments are activated in response to the received control message. As with step 730, in step 760 the activation of one or more light element in response to a control message in some embodiments is based, in whole or in part, on a configuration made in step 710. Activating one or more light element in step 760 in some embodiments switch one or more light element between an on/off status, in some embodiments modify the color or intensity emitted by one or more light element, in some embodiments alter (or initiate or stop) the pattern of flashes of one or more light element, or otherwise modify the behavior of one or more light element. The activation of one or more local light element in step 760 in some embodiments vary based upon the time of day, the status of the lighting device or an individual light element (such as what color of light is being emitted in response to a prior input), etc. Such variations in some embodiments are designated in configuration step 710 in some examples. In some examples, a lighting device or an individual light element in some embodiments cycle through a number of predetermined levels (which in some embodiments is predetermined for all lighting devices of a particular type in accordance with the present invention or predetermined at configuration step 710), with a shift made from one level to another made for each input received, whether the input is received locally (as in step 730) or remotely (as in step 760).

In step 770, if one or more light element has been activated either by a local input or a control message received from a remote lighting device, the activation level of the light element in some embodiments is adjusted as a function of time. For example, step 770 in some embodiments decrease the intensity of the light emitted by a light source in increments until the intensity is eventually reduced to zero. Step 770 in some embodiments thereafter return to step 720 and, ultimately, step 750 to receive local inputs and control messages, respectively. Method 700 in some embodiments continue until the light source is disconnected from power source.

In some further examples in accordance with the present invention, a local input detection (such as by step 720 of method 700) and/or the receipt of a control message (such as by step 750 of method 700) in some embodiments return method 700 to configuration step 710 if the input/control message meets certain parameters. For example, a touch-input in a certain pattern or a control message containing a particular command in some embodiments return a lighting device to a mode that permits a user to configure the device.

Systems and methods in accordance with the present invention, such as method 700 and lighting device 200, in some embodiments permit individuals to use two or more associated lighting devices to communicate over great distances. For example, a grandmother in some embodiments touch her lighting device to activate her grandson's lighting device. As a result of his lighting device activating, the grandson would then know that his grandmother was thinking of him, even if the two of them and their respective lighting devices are separated by many miles, or even continents or oceans.

While systems and methods in accordance with the present invention in some embodiments provide output devices such as displays (or in some embodiments display information using software operating on a computing device such as a smartphone or a PC), in many examples, such as some of those described herein, a lighting device in accordance with the present invention primarily or solely outputs information using the one or more light elements incorporated into the lighting device. Similarly, a lighting device in accordance with the present invention in some embodiments provide various input devices, but as described in some examples herein in some embodiments primarily or solely use a touch-based input system. Accordingly, a lighting source in accordance with the present invention in some embodiments optionally provide information about its status using one or more incorporated lighting element. While the present invention is not limited to any particular schema for indicating the status of a lighting device, some examples of a schema for indicating the status of a lighting device in accordance with the present invention are described below.

For example, a lighting device in accordance with the present invention in some embodiments indicate status and errors with pulses. For example, when first plugged in, a lighting device in some embodiments slowly pulse green to indicate that it is searching for a known Wi-Fi connection. If no known Wi-Fi connection is found, the lighting device in some embodiments change to more rapidly pulsing orange. If the lighting device establishes a Wi-Fi connection, the light emitted in some embodiments turn red to indicate that the device is searching for a software or firmware update from a server (sometimes referred to as a broker) accessed over one or more network. A green light in some embodiments indicate that a “handshake” between the lighting device and the broker is in progress. After accessing an update or determining that no update is needed, the lighting device in some embodiments produce a mix of colors as a “celebratory rainbow” to indicate to the user that power-up has been successful. Other visual indicators that in some embodiments are provided to a user are: a fast blue pulse to indicate that a Wi-Fi connection has been made but that no Internet connection was established (such as in some embodiments occur if a router is working but a modem is not, for example); a fast red pulse to indicate that a certificate failure with the MQTT broker (described further below), which in some embodiments indicate that a hacking event has occurred; and a slow purpose pulse to indicate that the lighting device is in configuration mode.

Lighting devices in accordance with the present invention in some embodiments communicate over networks and/or data connections using various protocols for exchanging information (such as control messages or configuration information), and/or to establish the identity of a lighting device, and/or for security purposes. While not limited to any particular protocol or combination of protocols, examples of the implementation of some protocols for these purposes are described below.

Lighting devices in accordance with the present invention in some embodiments communicate through Wi-Fi using the SSL/TLS 1.2 protocol. Lighting devices in some embodiments share one or more private key hardcoded in software or hardware included on the device or stored in EEPROM or other memory to permit the key(s) to be updated. Each lighting device in some embodiments have a unique identification. One way to provide a unique identification for each lighting device is to use a unique identifier included in a wireless communication module used to enable a Wi-Fi or other type of wireless communication.

Upon start-up, a lighting device in some embodiments read one or more stored Wi-Fi name and password stored on EEPROM within the device. As the device attempts to connect to the Wi-Fi, it in some embodiments provide a slow green pulse; if connection fails, the device in some embodiments provide a fast orange pulse. After a failure to connection, a device in some embodiments once again attempt to connect to the Wi-Fi after two minutes have elapsed. After successfully connecting to Wi-Fi and the Internet, a lighting device in some embodiments contact a server (an IP address or domain name for the server in some embodiments optionally be hardcoded in software, firmware, or hardware included in the device, or in some embodiments is stored in EEPROM or other memory) using the device's private key to check for firmware or software updates. A server in some embodiments optionally is dedicated solely to distributing firmware/software updates to lighting devices. To check for an update, a lighting device in some embodiments provide the server: the unique identifier of the lighting device, the firmware or software version of the lighting device, and an API key for security. The server in some embodiments respond with: an indication that no update is available, an indication of an API key failure, or by sending an available update to the lighting device. If an update is available, the server in some embodiments also send the size of the update and an md5 checksum to confirm the integrity of the transmitted update. If the update is successfully received (for example, if the security checks match), the lighting device in some embodiments reboot and a bootloader in some embodiments copy the contents of the new update over the prior firmware (or software) to restart the start-up process.

After a successful connection to the internet and an update check, a lighting device in some embodiments attempt to connect to an MQTT broker. A greenish-blue light in some embodiments from the lighting device in some embodiments signify the process of contacting the MQTT broker. To connect to the MQTT broker, the lighting device in some embodiments use TLS/SSL and the hardcoded private key contained on the device. The lighting device in some embodiments also is provided with a client ID prefix that must be correct to successfully connect to the MQTT broker in order to provide an additional layer of security. Upon successful connection, the lighting device in some embodiments subscribe to one or more channel to provide a way to send messages uniquely to the lighting device, as well as to all lighting devices in accordance with the present invention.

A lighting device in accordance with the present invention in some embodiments also read its EEPROM to determine what group message channels to subscribe to with the MQTT broker. For example, a device in some embodiments subscribe to as many as a maximum number of groups, such as sixteen groups. Such groups in some embodiments define the other lighting devices in accordance with the present invention that are associated with an individual lighting device. For example, if lighting devices A, B, and C subscribe with the MQTT broker, a first group in some embodiments include A and B while a second group in some embodiments include B and C, with no group containing A and C (although such a group could be formed, it need not be formed). The individual lighting device in some embodiments publish to associated devices that the lighting device is online, as well as the group(s) the device is subscribed to and the firmware version the device is running. A lighting device in some embodiments also send a message to indicate that it is being powered off in order to indicate that the device is offline until it re-establishes a connection. Messages to and/or from a lighting device in some embodiments is in the JSON format. A lighting device in some embodiments parse received messages for an identification corresponding to itself and disregard any such message, as the subscribed channel in some embodiments relay messages that the lighting device sent to other associated lighting devices.

While lighting devices in accordance with the present invention in some embodiments have a built-in real time clock, or RTC, they in some embodiments have one or more mode that limits or eliminates the reaction of the lighting device to a control message and/or a local input. For example, a lighting device used by a child in some embodiments is placed in a mode that prevents activation of a light element(s) during specified times to avoid disturbing the child's sleep. In order for a lighting device to know the current time without a built-in RTC, a proxy in some embodiments append a time onto every message sent through the server. When initially configured, the lighting device in some embodiments store in EEPROM the difference between the time indicated by the server and the local time. The stored difference in some embodiments are used to calculate the local time when a message is received, thereby permitting the lighting device to respond appropriately to a received message. In some examples, a lighting device in some embodiments is entirely prevented from illuminating during a timeframe, while in others the lighting device in some embodiments illuminate at a low intensity during those time periods.

The initial configuration, or subsequent re-configuration, of a lighting device in accordance with the present invention in some embodiments occur within a predetermined amount of time after the device is connected to a power source. The predetermined amount of time after power-up during which a lighting device in some embodiments is configured to be two minutes, but other amounts of time are used in other various embodiments accordance with the present invention. During configuration, a lighting device in some embodiments transmit a “Soft AP” or “Access Point” signal, which is an SSID that permits any Wi-Fi enabled device to be connected to the lighting device. A user in some embodiments connect to the lighting device using a computing device, such as a PC, smartphone, or tablet computer, to configure the lighting device. In order to access the lighting device for configuration, the user in some embodiments is required to enter information provided to a purchaser of the device, such as a unique name or other identifier and a password. Some or all of such information in some embodiments is provided in product packaging and/or upon the lighting device itself. The configuration process in some embodiments permit a user to provide a Wi-Fi network name and password (if required), to associate the lighting device with one or more other lighting device, to define the alteration of illumination to be made in response to various inputs, to define one or more time during which no or a limited response will be made to messages from associated lighting device, to specify the local time (and thereby obtain the difference between the time of the server and the local time), and/or other parameters. As part of configuration, as well as ongoing operation of a lighting device in accordance with the present invention, the lighting device in some embodiments use a Wi-Fi network and an Internet connection to access one or more server. The server(s) accessed in some embodiments are reached using an IP address hardcoded into the lighting device or otherwise provided.

The adjustment of light output by a lighting device as a function of time, one example of which is described in conjunction with step 770 of method 700 in the example of FIG. 7, in some embodiments occur in a variety of fashions. In one example, the brightness and color of light emitted in some embodiments are adjusted every three milliseconds after an input (whether a local input or a remote input), with a total time to deactivating the light entirely (absent another input) within a specified period of time, such as one half hour, one and a half hours, eight hours, twenty-four hours, etc. The frequency of such updates and/or the total time to deactivate the light in some embodiments vary from this example and/or in some embodiments are configurable by a user.

In some examples of conventional network configurations, a firewall provided by a router or a switch in some embodiments is present between light sources (such as light source 110, 120) and a server (such as server 190), and in such an example the IP address of the firewall in some embodiments is provided to the server(s) for use to route communications to a light source. Such a firewall will also often prevent the server(s) from initiating a connection with a light source. In such examples, a light source in some embodiments initially open a communication channel with the server(s), with messages sent from the light source to the server(s) at periods (such as every sixty seconds) to keep that communication channel open, thereby permitting the server(s) to use the open channel to send communications to the light source. If the connection between a light source and a server is broken, the light source in some embodiments seek to re-initiate the connection. If the attempted re-initiation of a connection with a server fails, a light source in some embodiments provide an appropriate error message for a user.

Systems and methods in accordance with the present invention enable a remote light source to activate or alter the operation of a local light source, and likewise permit a local light source to activate or alter the operation of a remote light source. Whether a given light source is “local” or “remote” is a matter of whether a given user is able to physically interact with the light source and perceive light emitted by the light source; a single light source in some embodiments is both a “local” light source and a “remote” light source at the same time.

In some embodiments a housing with a screen is provided. In such embodiments, the screen is an LCD screen or the like, which displays one or more image on the display. The housing includes a main portion, a front face, a light, and a rear portion. The screen is disposed within the main portion and proximate a front face of the main portion. In some embodiments, the front face of the housing is open so that the screen in some embodiments is viewed from within the housing. The light is similar to the light sources disclosed herein and is disposed on the main portion of the housing. In some embodiments, the light is disposed around a perimeter of the housing, such that the light is centralized around at least a portion of the perimeter of the housing. The housing includes a power source, such as a battery, a wireless interface, and a controller. The controller in some embodiments is a microprocessor and/or other logic circuitry configured to perform various operations. In some embodiments, the controller is configured to receive a color input from a user, to select and display a user identifying image on the screen, and to change a color of the light source in response to the user input. The controller in some embodiments also is configured to receive and store new identifying images from a remote location. As will be appreciated, the power source is configured to provide power to the light source and the LCD screen. The wireless interface is configured to receive and identify images from a remote location and/or to transmit light color and image data to the remote location. The controller in some embodiments also is configured to display a plurality of different colors of light emitted from the light source.

In some embodiments, the front and rear faces of the housing are roughly rectangular shaped. In some embodiments, the front face of the housing is open. In some embodiments, the rear face is also open. In other embodiments, the housing is square or cube shaped. In some embodiments, the housing is cylindrical or spherical. It will be appreciated that other shapes are used for the housing in various embodiments.

In some embodiments, there are multiple open faces in the housing. Screen display faces in some embodiments are placed in communication with one or more open faces so that when disposed inside the housing they are still viewable through the open faces. In this way, a plurality of screens are capable of being used with the housing.

In some embodiments, the housing further includes a speaker or the like for playing a sound recording or other audio. In some embodiments, the speaker is configured for playing prerecorded messages and other audio or sound recordings.

In some embodiments, the housing further includes a microphone for recording a message. As discussed herein, the audio is recorded and stored. In some embodiments, the recorded audio is associated with a user or group of users. The controller in also is configured to receive and store new audio recordings from a remote location. As will be appreciated, the power source is configured to provide power to the speaker and microphone. The wireless interface is configured to receive and identify audio recordings from a remote location and/or to transmit audio to the remote location.

In some embodiments, audio is transmitted from one source to another in real time. In some embodiments, the audio in some embodiments is transmitted in cooperation with light and/or an image.

As disclosed throughout the present disclosure, a user is associated with a particular light source, pattern, and/or color. In some embodiments, the user is further associated with one or more identifying image, such as a photo, avatar, icon, video, or the like. In some embodiments, the user is further associated with a sound recording or other audio. The user uploads the image to the system and it is linked or otherwise associated with the user and/or the device of the user. The linking in some embodiments is local, such that the image is stored on a device of the user, or it in some embodiments is centralized and/or global, such that the image and the associated link are distributed to one or more devices associated with a group of users and/or centrally stored. In some embodiments, the user is able to select which image is displayed through a user interface. In other embodiments, the user is unable to select which image is displayed and the system automatically selects a most recent image or an image that is most associated with the user and/or a particular light color/pattern/source.

In some embodiments, the user is in a group of users and the group of users are represented by a group identifying image that is displayed on the housing or otherwise associated with light emitted from the housing. The group identifying image is linked to a group of users, or the group identifying image is linked to a group of users at a particular time period, location, or during particular circumstances. In some embodiments, the group identifying image is selected for display based on shared characteristics of the group of users and/or a predetermined association between the group of users. In some embodiments, the group identifying image is selected based on user interactions with the housing and/or the system.

In some embodiments, the user is able to upload a single image and any subsequent images replace a stored image, while in other embodiments multiple images are associated with a user. The system further includes a memory for storing a plurality of different identifying images and a controller for selecting one or of the stored images to be displayed on the screen in response to a user interaction with the housing. The controller is also configured to receive and store new identifying images from a remote location. In some embodiments, the controller is also configured to receive and store new identifying images from a local location. For example, a user uploads an image stored locally on his computer or another device.

The product further includes a power source for providing power to the light source, the LCD screen, and/or the speaker. The product in some embodiments also includes a wireless interface for receiving and identifying images from a remote location and/or for transmitting light color and image data to the remote location. The product in some embodiments also is configured to display a plurality of different colors of light emitted from the light source. In some embodiments a user selects an image to display and/or use the device to control the color and/or pattern of the light emitted by the light source. The device in some embodiments is capable of being controlled by another device, such as a smartphone or the like.

In some embodiments, when a sending user interacts with the housing, by way of changing a color, the system identifies the color as well as the image of the user and links the two. The user-color relationship is stored in the memory and/or associated with the sending user's account. The system then sends information across a data connection related to both the color of the light selection as well as the linked identifying image to a remote implementation of the product. In some embodiments, this occurs automatically whenever the user interacts with the housing. In some embodiments, this is only initiated when the user further indicates the information should be sent, such as when the user presses a “send message” button or the like. The remote implementation of the produce receives the information and changes the color of the light and displays the image on the screen of the remote user. This enables a receiving user to immediately and readily identify the sending user. In some embodiments, there are multiple users within a group and the various devices associated with the multiple users display the color and/or image associated with the user. In some embodiments, the image is linked to the user's account and stored in memory. In some embodiments, the user is able to upload their own custom image. In some embodiments, where the user has multiple images associated with their account, the remote device displays a selected/preferred image, a random image, or a sequence of images on the display.

Advantageously, this provides the ability to more quickly identify a sending user within a group of users, as the receiving user will be shown the identifying image of the sending user. This enables larger functional groups of users to engage with the system and one another while being able to immediately and readily identify the sending user. It will be appreciated that the screen is compatible and interfaces with the various networks, processors, controllers, memories, and the like disclosed herein.

Various embodiments of the computer program, system, and method of embodiments of the present invention are implemented in hardware, software, firmware, or combinations thereof, which broadly comprises server devices, computing devices, and a communications network. Various embodiments of the server devices include computing devices that provide access to one or more general computing resources, such as Internet services, electronic mail services, data transfer services, and the like. In some embodiments the server devices also provides access to a database that stores information and data, with such information and data including, without limitation, account information, NLU model information, campaign information, personality information, or other information and data necessary and/or desirable for the implementation of the computer program, system, and method of the present invention, as will be discussed in more detail below.

Various embodiments of the server devices and the computing devices include any device, component, or equipment with a processing element and associated memory elements. In some embodiments the processing element implements operating systems, and in some such embodiments is capable of executing the computer program, which is also generally known as instructions, commands, software code, executables, applications (apps), and the like. In some embodiments the processing element includes processors, microprocessors, microcontrollers, field programmable gate arrays, and the like, or combinations thereof. In some embodiments the memory elements are capable of storing or retaining the computer program and in some such embodiments also store data, typically binary data, including text, databases, graphics, audio, video, combinations thereof, and the like. In some embodiments the memory elements also are known as a “computer-readable storage medium” and in some such embodiments include random access memory (RAM), read only memory (ROM), flash drive memory, floppy disks, hard disk drives, optical storage media such as compact discs (CDs or CDROMs), digital video disc (DVD), Blu-Ray™, and the like, or combinations thereof. In addition to these memory elements, in some embodiments the server devices further include file stores comprising a plurality of hard disk drives, network attached storage, or a separate storage network.

Various embodiments of the computing devices specifically include mobile communication devices (including wireless devices), work stations, desktop computers, laptop computers, palmtop computers, tablet computers, portable digital assistants (PDA), smart phones, wearable devices and the like, or combinations thereof. Various embodiments of the computing devices also include voice communication devices, such as cell phones or landline phones. In some preferred embodiments, the computing device has an electronic display, such as a cathode ray tube, liquid crystal display, plasma, or touch screen that is operable to display visual graphics, images, text, etc. In certain embodiments, the computer program of the present invention facilitates interaction and communication through a graphical user interface (GUI) that is displayed via the electronic display. The GUI enables the user to interact with the electronic display by touching or pointing at display areas to provide information to the user control interface, which is discussed in more detail below. In additional preferred embodiments, the computing device includes an optical device such as a digital camera, video camera, optical scanner, or the like, such that the computing device is capable of capturing, storing, and transmitting digital images and/or videos.

In some embodiments the computing devices includes a user control interface that enables one or more users to share information and commands with the computing devices or server devices. In some embodiments, the user interface facilitates interaction through the GUI described above or, in other embodiments comprises one or more functionable inputs such as buttons, keyboard, switches, scrolls wheels, voice recognition elements such as a microphone, pointing devices such as mice, touchpads, tracking balls, styluses. Embodiments of the user control interface also include a speaker for providing audible instructions and feedback. Further, embodiments of the user control interface comprise wired or wireless data transfer elements, such as a communication component, removable memory, data transceivers, and/or transmitters, to enable the user and/or other computing devices to remotely interface with the computing device.

In various embodiments the communications network will be wired, wireless, and/or a combination thereof, and in various embodiments will include servers, routers, switches, wireless receivers and transmitters, and the like, as well as electrically conductive cables or optical cables. In various embodiments the communications network will also include local, metro, or wide area networks, as well as the Internet, or other cloud networks. Furthermore, some embodiments of the communications network include cellular or mobile phone networks, as well as landline phone networks, public switched telephone networks, fiber optic networks, or the like.

Various embodiments of both the server devices and the computing devices are connected to the communications network. In some embodiments server devices communicate with other server devices or computing devices through the communications network. Likewise, in some embodiments, the computing devices communicate with other computing devices or server devices through the communications network. In various embodiments, the connection to the communications network will be wired, wireless, and/or a combination thereof. Thus, the server devices and the computing devices will include the appropriate components to establish a wired or a wireless connection.

Various embodiments of the computer program of the present invention run on computing devices. In other embodiments the computer program runs on one or more server devices. Additionally, in some embodiments a first portion of the program, code, or instructions execute on a first server device or a first computing device, while a second portion of the program, code, or instructions execute on a second server device or a second computing device. In some embodiments, other portions of the program, code, or instructions execute on other server devices as well. For example, in some embodiments information is stored on a memory element associated with the server device, such that the information is remotely accessible to users of the computer program via one or more computing devices. Alternatively, in other embodiments the information is directly stored on the memory element associated with the one or more computing devices of the user. In additional embodiments of the present invention, a portion of the information is stored on the server device, while another portion is stored on the one or more computing devices. It will be appreciated that in some embodiments the various actions and calculations described herein as being performed by or using the computer program will actually be performed by one or more computers, processors, or other computational devices, such as the computing devices and/or server devices, independently or cooperatively executing portions of the computer program.

A user is capable of accessing various embodiments of the present invention via an electronic resource, such as an application, a mobile “app,” or a website. In certain embodiments, portions of the computer program are embodied in a stand-alone program downloadable to a user's computing device or in a web-accessible program that is accessible by the user's computing device via the network. For some embodiments of the stand-alone program, a downloadable version of the computer program is stored, at least in part, on the server device. A user downloads at least a portion of the computer program onto the computing device via the network. After the computer program has been downloaded, the program is installed on the computing device in an executable format. For some embodiments of the web-accessible computer program, the user will simply access the computer program via the network (e.g., the Internet) with the computing device.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

1. A communicative lighting system, the system comprising:
a first light source, the first light source including at least one input mechanism, at least one light output mechanism, at least one screen configured to display one or more identifying images, and a permanently assigned first identifier;
a second light source, the second light source including at least one input mechanism, at least one light output mechanism, at least one screen configured to display one or more identifying images, and a permanently assigned second identifier; and
a server connected to at least one network accessible to both the first light source and the second light source, the server receiving messages from at least the first light source and the second light source to associate the first light source and the second light source with one another, such that when an input is made using the at least one input mechanism at the first light source the operation of the at least one light output mechanism and at least one screen of the second light source alters and such that when an input is made using the at least one input mechanism at the second light source the operation of the at least one light output mechanism and at least one screen of the first light source alters.

2. The communicative lighting system of claim 1, wherein said first and second light source further include an audio output mechanism.

3. The communicative lighting system of claim 2, wherein an input made using the at least one input mechanism at the first light source further alters the operation of at least one audio output mechanism of the second light source and an input made using the at least one input mechanism at the second light source further alters the operation of the at least one audio output mechanism of the first light source.

4. The communicative lighting system of claim 1, wherein said first and second light source further includes a main housing portion, said main housing portion including an open front face.

5. The communicative lighting system of claim 4, wherein said light output mechanism is a light disposed around the perimeter of said main housing portion.

6. The communicative lighting system of claim 4, wherein a screen is disposed within said main housing portion and proximate to said open front face such that it is viewable from within said main housing portion.

7. The communicative lighting system of claim 1, wherein said first and second light source further include a power source.

8. The communicative lighting system of claim 1, wherein said first and second light source further include a controller configured to receive and store identifying images.

9. The communicative lighting system of claim 1, wherein at least one screen is an LCD screen.

10. The communicative lighting system of claim 1, wherein said screens are configured to display videos.

11. A communicative lighting system, the system comprising:
a housing
a screen disposed within the housing; and
a light source disposed within the housing and configured to emit a light,
wherein the screen is configured to display one or more identifying images, and
wherein when a sending user interacts with the housing, the color of the light emitted by the light source and the identifying image are linked to one another and sent to a remote implementation of the product, such that the remote product then displays the light color from the light source and the identifying image.

12. The communicative lighting system of claim 11, wherein the light source is disposed around the perimeter of said housing.

13. The communicative lighting system of claim 11, further comprising an audio source configured to output audio.

14. The communicative lighting system of claim 13, wherein when said sending user interacts with the housing, said audio recording is also linked to the light source and the identifying image and sent to said remote implementation of the product, such that said remote product also outputs said audio recording.

15. The communicative lighting system of claim 13, wherein said audio source is further configured to output live audio.

16. The communicative lighting system of claim 11, wherein said screen is further configured to display identifying videos.

17. The communicative lighting system of claim 13, wherein said screen is further configured to display identifying videos, and wherein said audio source is further configured to output identifying audio associated with an identifying video.

18. A method for communication over distances, the method comprising:
powering on a first display device by touching a touch-sensitive surface;
associating said first display device to a second display device;
determining when a local input has been received by said first display device;
sending of a message by said first display device based upon the local input;
receiving of said message by said second display device; and
displaying an image on a screen associated with said second device upon receipt of said message.

19. The method of claim 18, further including the step of activating light elements associated with said second device upon receipt of said message.

20. The method of claim 18, wherein the image displayed is a video.
